(19) United States
(12) Patent Application Publication
(10) Pub. No.: US 2014/0214279 A1
(43) Pub. Date: Jul. 31, 2014

(54) SEATBELT LOCKOUT SYSTEM

(71) Applicant: TOBY BUNTON, Smithville, MO (US)

(72) Inventor: TOBY BUNTON, Smithville, MO (US)

(21) Appl. No.: 13/414,714

(22) Filed: Mar. 7, 2012

(51) Int. Cl. B60K 28/10; F02D 17/04

(52) U.S. Cl. 701/45

(57) ABSTRACT

A seatbelt lockout system for seatbelt use compliance in a vehicle, comprising: an ignition switch, where the ignition switch controls ignition of an engine within the vehicle; a bladder placed in at least one vehicle seat, where the bladder detects pressure from the weight of an occupant; a seatbelt system associated with the at least one vehicle seat; plurality of sensors, including a bladder sensor and a seatbelt sensor, where the bladder sensor confirms the weigh of the occupant and the seatbelt sensor detects the engagement and non-engagement of the seatbelt system; and a computer control system, where the computer control system receives signals from the plurality of sensors.

### BACKGROUND OF THE INVENTION

1. Field of Invention

The present invention relates to a seatbelt lockout system to disable a vehicle engine if seatbelts are not properly worn.

2. Description of Related Art

Many vehicles are equipped with occupant detection systems in order to activate or deactivate various safety restraints within a vehicle. Some systems are provided to detect vehicle occupancy to deactivate or activate airbags or other pyrotechnical deployed restraints. This feature may further control the deployment of the restraints. Based upon sensors provided in the vehicle occupant detection system. Further the vehicle occupation detection systems are usually controlled through the use of sensors and computer programs to consequently activate or deactivate airbags and may control the degree of deployment of the airbags. Examples of vehicle occupant detection systems used in conjunction with airbags are disclosed in Fortune et al., U.S. Pat. No. 6,101,436 and Joseph, U.S. Patent Publication 2004/0066023. Both of these references reflect the ability to utilize the vehicle occupant detection systems with the use of a seat bladder in conjunction with an airbag restraint. Consequently it would be advantageous to use a similar vehicle occupant detection system in conjunction with a seatbelt to ensure occupants are utilizing seatbelts.

Seatbelt safety has been proven to prevent bodily injury and potentially save the lives of car occupants in an automobile collision, and yet many people refrain from taking this preventative safety measure. There are currently limited alternatives to the traditional seatbelt sensors that are found in most cars, which notify vehicle occupants but take no forcible action to impair vehicle operation.

### SUMMARY OF THE INVENTION

The present invention relates to a seatbelt lockout system for seatbelt use compliance in a vehicle, comprising: an ignition switch, where the ignition switch controls ignition of an engine within the vehicle; a bladder placed in at least one vehicle seat, where the bladder detects pressure from the weight of an occupant; a seatbelt system associated with the at least one vehicle seat; plurality of sensors, including a bladder sensor and a seatbelt sensor, where the bladder sensor confirms the weigh of the occupant and the seatbelt sensor detects the engagement and non-engagement of the seatbelt system; and a computer control system, where the computer control system receives signals from the plurality of sensors. The computer control system may be placed in a glove box of the vehicle. In one particular embodiment, the seatbelt sensor may include diode and the seatbelt system includes an audio alert. In one given parameter, the bladder sensor detects any occupant weighing 60 lbs or greater.

### BRIEF DESCRIPTION OF DRAWINGS

FIG. 1 illustrates a side and overhead perspective view of a seatbelt lockout system, according to the present invention.

### DETAIL DESCRIPTION

The present invention provides a system to disable a vehicle engine if seatbelts are not properly worn that prevents an automobile from starting if there are occupants with disengaged seatbelts. The present invention includes the use of a seatbelt lockout system, which prevents the ignition of a vehicle unless the vehicle seatbelts are engaged by occupants. Occupants are detected through the use of bladders placed in the seat of the vehicle and electronics implemented within the seatbelt tied to control systems in conjunction with the ignition switch. Upon a detection of a vehicle occupant as detected by the seat bladder, the ignition switch is deactivated until a sensor, which detects the fastening of seatbelts associated with each occupied vehicle seat. Once the occupant fastens the seatbelt the system allows for the ignition of the vehicle and therefore prevents the use of the vehicle without proper fastening seatbelt by the occupant. Software residing in memory within the computer controls controls the sensors associated with the ignition, seat bladder and seatbelt. In one particular embodiment, the computer control system is placed within the glove box of a vehicle. This placement of the control system will offer the user easy access to the control systems and the activation of the system is readily available.

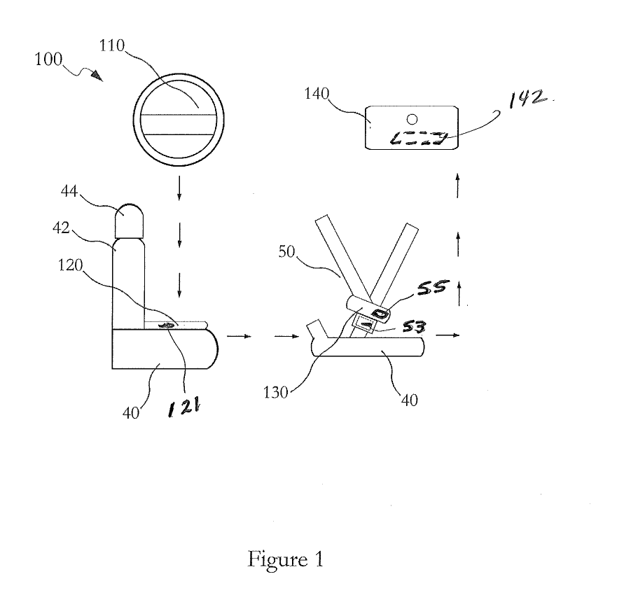

FIG. 1 illustrates a perspective view of a seatbelt lockout system 100, according to the present invention. The seatbelt lockout system 100 includes a key ignition switch 110, a bladder 120 that can detect over 60 lbs. of pressure, a computer chip 130, a seat belt 50 and a glove box 140 with a plurality of computer controls inside, not shown. The seatbelt 50 is equipped with a diode programmed along with an anti-theft key, so that the seatbelt 50 is connects to complete the circuit before ignition can start. The ignition switch 110 is programmed to relay to the computer control system that the seatbelt is connected and that the bladder 120 is receiving over 60 lbs. of pressure before the ignition takes place. The computer control system is able to run all checks before releasing the vehicle to be started. The control system is tied into an anti-theft ignition program since the seatbelt 50 includes a dialed-in diode that can send a connection signal, which will tie into a seatbelt audible alert as well as a seatbelt warning light. The seatbelt lockout system 100 features an adjustable timer, which emits an audible warning sound to inform a driver prior to the automobile's engine being shut down. The designed timer of the seatbelt lockout system can be customized according to the driver's specifications.

The seatbelt lockout system can assure seatbelt usage compliance before the ignition is enabled on any automobile or other vehicle. The seatbelt lockout system functions much like an ignition interlock system but is specifically designed for seatbelts and their proper usage. The seatbelt lockout system is an electrically controlled device (ECD) powered by an automobile's battery. The seatbelt lockout system detects when the seatbelt is disengaged, is worn in an incorrect manner, or when the belt is buckled improperly and prevents drivers from starting the automobile. A pressure sensor is used to detect human weight on a seat, and the seatbelt lockout system utilizes a diode on each seatbelt to transmit an electronic signal to the main operating program. The seatbelt lockout system will be readily available for all new vehicle makes and models, and will also be available for purchase as an aftermarket accessory.

1. A seatbelt lockout system for seatbelt use compliance in a vehicle, comprising:
an ignition switch, where the ignition switch controls ignition of an engine within the vehicle;
a bladder placed in at least one vehicle seat, where the bladder detects pressure from the weight of an occupant;
a seatbelt associated with the at least one vehicle seat;
plurality of sensors, including a bladder sensor and a seatbelt sensor,
where the bladder sensor confirms the weight of the occupant and the seatbelt sensor detects the engagement and non-engagement of the seatbelt; and
a computer control system, where the computer control system receives signals from the plurality of sensors; and
an adjustable timer, where the adjustable timer emits an audible warning sound warning of the vehicle's imminent shut down.

2. The seatbelt lockout system according to claim 1, where the computer control system is placed in a glove box of the vehicle.

3. The seatbelt lockout system according to claim 1, where the seatbelt sensor includes diode.

4. The seatbelt lockout system according to claim 1, where the seatbelt system includes an audio alert.

5. The seatbelt lockout system according to claim 1, where the bladder sensor detects any occupant weighing 60 lbs or greater.
